(19) United States
(12) Patent Application Publication
(10) Pub. No.: US 2003/0223639 A1
(43) Pub. Date: Dec. 4, 2003

(54) Calibration and recognition of materials in technical images using specific and non-specific features

(76) Inventors: Vladimir Shlain, Haifa (IL); Maty Moran, Moshava (IL); Netanel Peles, Ramat-Hasharon (IL); Tatyana Dembinsky, Nesher (IL); Andrew Gleibman, Yokneam-Illit (IL)

Correspondence Address: DANIEL J SWIRSKY, PO BOX 2345, BEIT SHEMESH, 99544, IL

(21) Appl. No.: 10/378,671

(22) Filed: Mar. 5, 2003

Related U.S. Application Data
(60) Provisional application No. 60/361,363, filed on Mar. 5, 2002.

(51) Int. Cl. G06K 9/46; G06K 9/66

(52) U.S. Cl. 382/190; 382/224

(57) ABSTRACT

A method of automatic recognition of different materials in image segments including correlating sample image segment features to classes of materials, and identifying viewed image segments as material segments in accordance with the correlating step.

### CROSS-REFERENCE TO RELATED APPLICATIONS

This application claims the benefit of U.S. Provisional Patent Application Ser. No. 60/361,363, filed Mar. 5, 2002, entitled “Calibration and Recognition of Materials in Technical Images Using Specific and Accompanying Non-Specific Features,” and incorporated herein by reference in its entirety.

### FIELD OF THE INVENTION

The present invention relates to automatic image understanding in general, and more particularly, to calibration and automatic recognition of different materials on technical images.

### BACKGROUND OF THE INVENTION

Various forms of automatic understanding are applied in processing of technical images. A technical device, such as a discrete portion of a die (or chip) on a semiconductor wafer, depicted in the image (FIG. 1a), may contain defects and other parts of interest, location of which may characterize the device or the nature or relevance of the defect. For instance, semiconductor layer image may contain defects, location of which relating to specific material segments like metal and dielectric is crucially important for defect classification and for diagnostics of the semiconductor device. For instance, a defect consisting of metal and covering two metal parts is almost certainly classified as a fatal defect which is irreparable as it may cause shorting. However, a metal defect touching only dielectric part of the device is not always so classified.

Calibration and automatic recognition of image segments related to different materials is a difficult problem. Color intensity histograms provide a partial decision for resolving this problem. The difficulty is that a specific material may manifest in various color characteristics even in the same image, not to say different images. This is the case, for instance, in semiconductor layers. When imaged by commercially used cameras, the same material may appear in different colors, or different materials may appear as the same color. In such situations, the color (or gray level)-based histogram fails to provide explicit identification. In many cases the illumination is unstable, resulting in spectrum variations that cannot be tolerated, especially when a one-time set up must be employed and must perform consistently over a long time and a large population of wafers. Furthermore, the semiconductor manufacturing process itself is subject to perturbations that often affect the color of materials being used, sometimes on the same wafer. Besides, due to different topographic densities, and partial transparency of the materials in use, different materials may bear the same, or nearly the same, color, and different images may depict the same semiconductor layer in different resolutions, which may result in different colors and textures for the same material. There is thus a need to identify materials on a wafer using other techniques in order to accurately ascertain their identity.

### SUMMARY OF THE INVENTION

The present invention provides a system and method for automatic material calibration and recognition in images that overcome disadvantages of prior art. In addition to color intensity related features, typically used for material recognition, features related to material segment morphology (like form and area) or to other characteristics of-the materials are applied.

In the calibration, or learning, phase of the material recognition process, the user may choose features that are of interest (specific and accompanying non-specific ones) that describe material segments (image segments containing certain materials), then select and name sample material segments of sample images, and then add features and corresponding names of those sample material segments to a special database related to a specific image set.

In the application (or “production”) phases, this database is applied in other images for recognition and localization of materials that have been defined during the learning phase. For the material in a material segment to be recognized, a method of classification is used, where features of similar sample material segments are found in the database, thus providing name and other information most relevant to the segment in question.

### BRIEF DESCRIPTION OF THE DRAWINGS

The present invention will be understood and appreciated from the following detailed description taken in conjunction with the attached drawings in which:

FIG. 1a is an illustration of examples of various material segments on a wafer illustrating some of their non-specific features, necessary for understanding of the present invention;

FIGS. 1b-f is an illustration of examples of material segments and their specific and non-specific accompanying features, necessary for understanding of the present invention;

FIGS. 2a-b are a simplified block flow illustration of a method for calibrating and utilizing for recognition of materials, operative in accordance with a preferred embodiment of the present invention;

FIG. 2c is an illustration of feature vector groups defining classes (different materials) for use in the “nearest neighbors” mode for classifying types of material in accordance with the method of FIGS. 2a-b;

FIG. 3a is an illustration of a defect and the method of characterizing the defect in order to ascertain its characteristics; and

FIG. 3b is a simplified block flow illustration of a method for characterizing defects utilizing the above methods of FIG. 1 and FIG. 2;

### GLOSSARY OF TERMS

The following terms are used throughout the specification and claims and are defined as follows:

Image segment: Enclosed area which has a contour. Image segment may encompass other image segments or be encompassed by another image segment.

Material segment: Image segment related to a specific material.

Feature: Characteristics of an Image segment which is used to identify it as a material segment. A feature may be specific, which depends on physical qualities of the material (e.g. color, color intensity). A feature also may be non-specific (accompanying), describing image segments related to occurrences of a specific material in the image (e.g. segment form, area, orientation etc).

Material calibration: Selecting Image segments in one or many of sample images, typically manually, then providing these segments with names describing the corresponding materials and storing these names along with features of the corresponding material segments.

Database of features and names of material segments: Storage for features and names of sample material segments determined during material calibration.

Material recognition: Automatic process of providing image segments related to specific materials with names describing the corresponding materials, thus designating image segments as material segments.

### DETAILED DESCRIPTION OF PREFERRED EMBODIMENTS

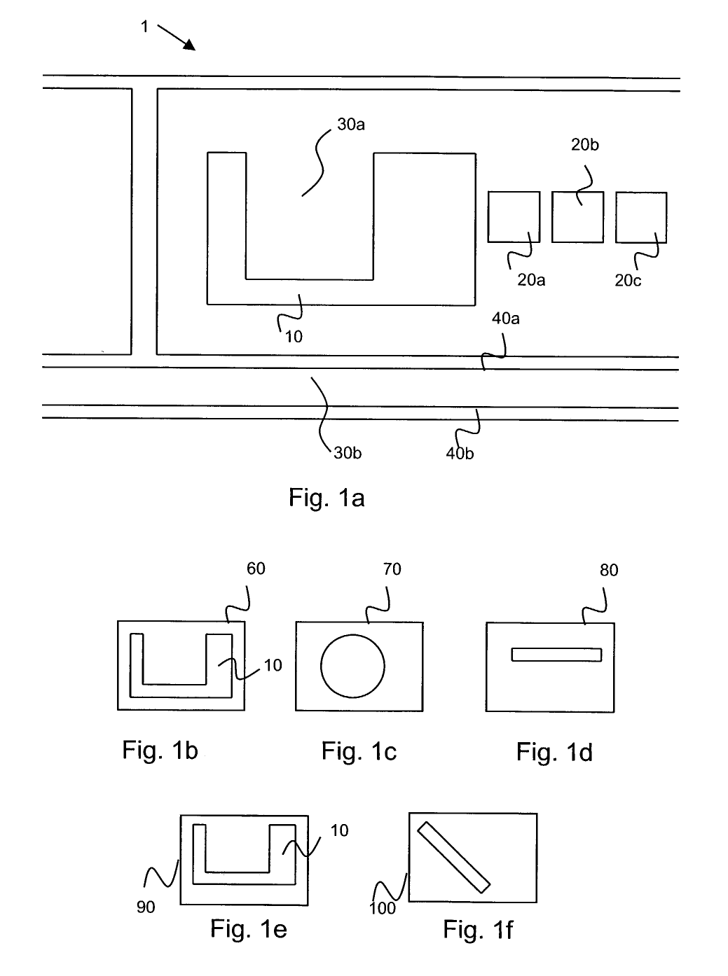

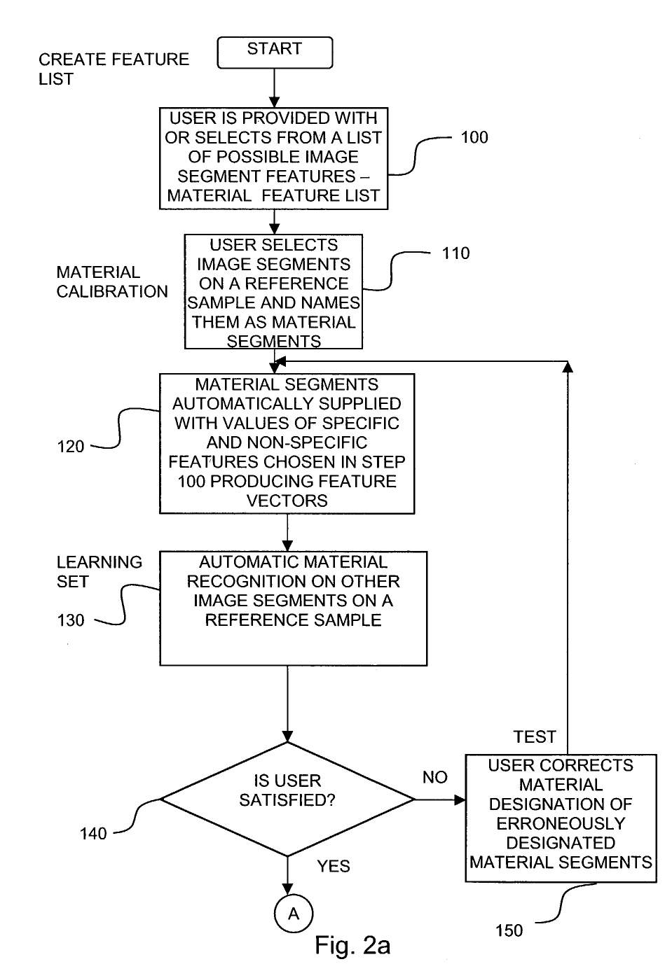

Reference is now further made to FIG. 1a which is an illustration of a wafer image 1 containing examples of various image segments. Wafer image 1 contains, for example, image segments 10,20,30,40 which display certain specific and non-specific features. Image segments having similar features (and hence related to similar materials) are designated by the same numbers. FIGS. 1b-f additionally referred to are diagrammatic illustrations of segments having non-specific features utilized to designate image segments as material segments i.e. to identify the materials from which the material segments are made. Examples of materials are metal and dielectric. A specific feature of a metal image segment or pattern may be the color (or gray level) of the image segments. The form of the image segments may be their accompanying feature, characterizing a majority of occurrences of the corresponding material in the image. Non-limiting examples of form include: bounding rectangle density (the degree to which the bounding rectangle is filled by the image segment) (FIG. 1b), circularity (the degree of similarity of the image segment to a circle) (FIG. 1c), elongation (length divided by breadth) (FIG. 1d), area (FIG. 1e), orientation (e.g. rotation, proximity to other similar or non-similar image segments) (FIG. 1f), texture, density. Other morphologic or topologic characteristics may be utilized as specific or non-specific features.

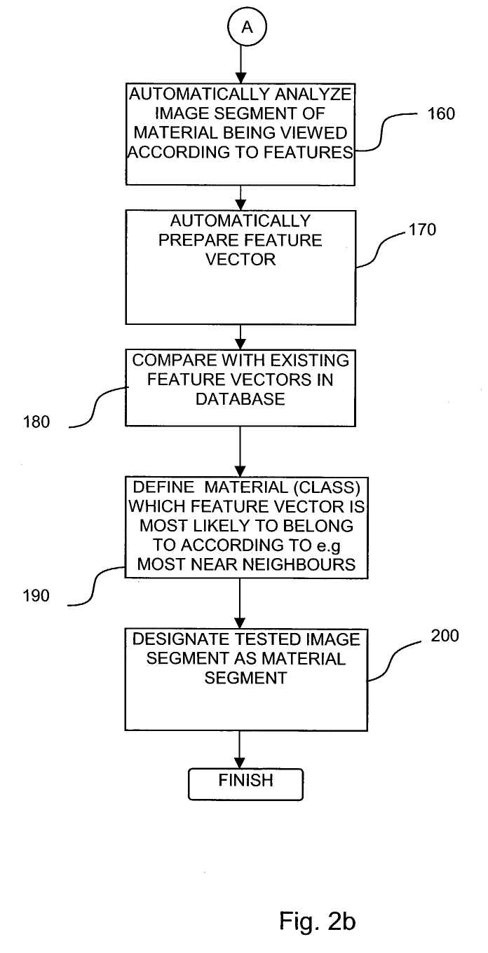

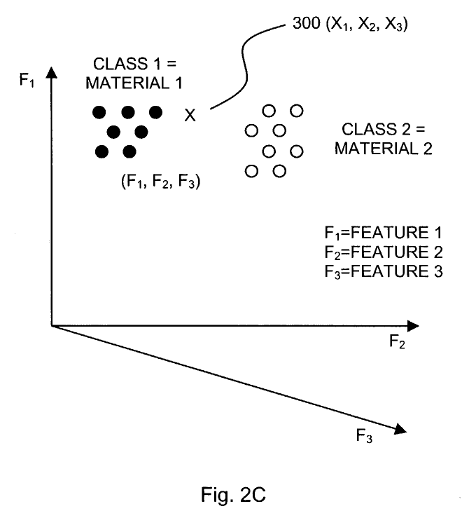

Reference is now made to FIGS. 2a-b which is a simplified block flow illustration of a method for calibrating and utilizing for recognition of materials, the method operative in accordance with a preferred embodiment of the present invention. Reference is made also to FIG. 2c which is an illustration of feature vector groups defining classes or different materials for use in the “nearest neighbors” mode for classifying types of material in accordance with the method of FIGS. 2a-b.

In step 100 of FIG. 2a, the user is provided with a list of possible image segment features which might be useful for identifying material segments from image segments. Examples of these features are described hereinabove. The user selects features in the list and thus creates an active material features list for use in the further steps of the method. The next stage is the calibration phase to produce a learning set of material segments which are correlated to their features. In step 110 the user selects image segments on a reference image sample and names them as material segments. In step 120 the material segments are automatically supplied with values of specific and nonspecific features chosen in step 100. Each of these material segments thus has a feature vector comprising features chosen from the feature list designated in step 100 and a corresponding class or material name. The user may select one or more image segments for each material, thus providing various examples having various features which may characterize the material. The corresponding feature vectors (marked as related to the corresponding materials) are stored in the Database of features and names of material segments. The next stage is the finalization or testing of the learning set or correcting for errors in automatic material recognition. At step 130 a new reference sample image may be brought and image segments are automatically designated as material segments. The image segments tested do not coincide with the segments which were previously manually calibrated. The designation might be done according to a user preselected color coding scheme chosen by the user to designate a particular material. At step 140 the user determines whether any of the image segments have been erroneously designated. If the user is not satisfied then at step 150 the user corrects erroneously designated material segments and the class or material corresponding to the feature vector is thus updated. The process is repeated until the user is satisfied. If the user is satisfied then the completed learning set of materials and corresponding feature vectors is stored in the database of features and names of material segments. The user may then automatically test image segments in the Application phase in order to classify them as material segments as shown in steps 160-200.

At step 160,170 features of image segments of an analyzed sample image on which material recognition is to be performed are automatically analyzed in order to ascertain their feature vectors. At steps 180,190 a comparison is then made with the existing stored feature vectors and a corresponding class or material is chosen corresponding to the closest match of feature vector to that of those stored. For example, using a “nearest neighborhood” method of classification as shown in FIG. 2c a feature vector 300 in the feature space corresponding to features (x1,x2,x3) has most neighbors corresponding to class 1 or material 1. Feature vector 300 is thus designated as material 1 and such designation is indicated (step 200). All image segments of an analyzed image may be processed in this way, thus resulting in complete material recognition.

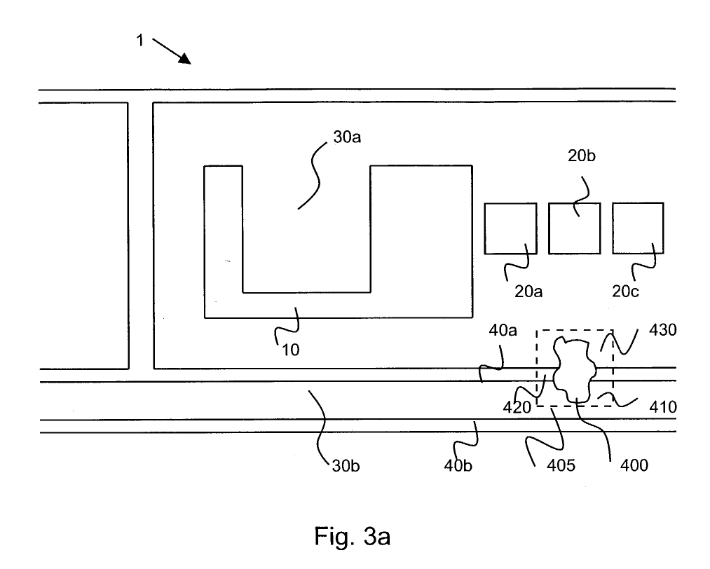

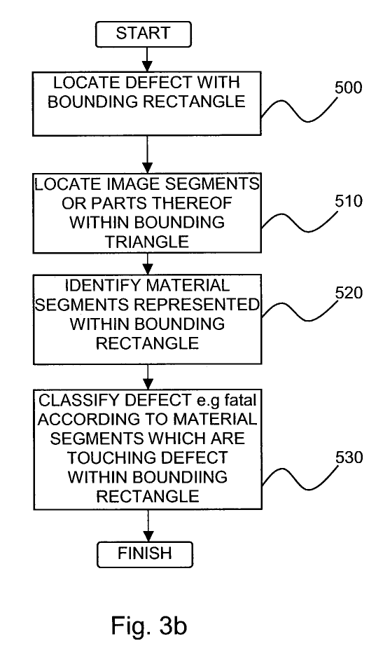

Reference is now made to FIG. 3a which is an illustration of a defect and the method of testing the defect in order to ascertain its characteristics and to FIG. 3b which is a simplified block flow illustration of a method for characterizing defects utilizing the abovementioned methods. Similar items to those in previous figures are designated by similar numerals.

The coordinates of defect 400 are ascertained and the defect is bounded with a rectangle 405 (step 500). At step 510 the image segments within the bounding rectangle are obtained, for example areas 410, 420 and 430 of bounding rectangle 405 contain parts of image segments 30b, 40a and 30a respectively. At step 520, the material segments represented in areas 410, 420 and 430 are identified as described hereinabove. At step 530 the defect is characterized according to which material segments (similar or different and which type of material) it is in contact with in the bounding rectangle. For example, a defect which contains material segments of metal touching each other is almost certainly a fatal or irreparable defect as it may cause shorting.

It is appreciated that one or more of the steps of any of the methods described herein may be omitted or carried out in a different order than that shown, without departing from the true spirit and scope of the invention.

While the methods and apparatus disclosed herein may or may not have been described with reference to specific hardware or software, it is appreciated that the methods and apparatus described herein may be readily implemented in hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method of automatic recognition of different materials in image segments comprising:
correlating sample image segment features to classes of materials; and
identifying viewed image segments as material segments in accordance with said correlating step.

2. A method according to claim 1 wherein said correlating step comprises:
selecting features of interest from a list of possible features;
manually selecting and naming as material segments sample reference image segments on a reference image sample; and
automatically supplying said material segments with values of features, thereby resulting in a feature value and corresponding material class.

3. A method according to claim 2 and further comprising:
automatically selecting sample reference image segments on a reference image sample not coinciding with said manually selected sample reference image segments;
automatically supplying said automatically selected sample reference image segments with values of features; and
automatically characterizing said automatically selected sample reference image segments as material segments in accordance with said values of features, thereby updating said feature value and corresponding material class.

4. A method according to claim 1 wherein said identifying step further comprises:
automatically supplying said viewed image segments with values of features; and
automatically classifying said viewed image segments as material segments in accordance with said values of features.

5. A method according to claim 1 and wherein any of said features comprises any of the following: color intensity, hue intensity, form, elongation, area, texture, and density.

6. A method according to claim 1 and wherein said identifying step comprises utilizing a nearest neighbor principle for comparison of said values of features with said learning set.

7. A system of automatic recognition of different materials in image segments comprising:
means for correlating sample image segment features to classes of materials; and
means for identifying viewed image segments as material segments in accordance with said correlating step.

8. A system according to claim 7 wherein said means for correlating comprises:
means for selecting features of interest from a list of possible features;
means for manually selecting and naming as material segments sample reference image segments on a reference image sample; and
means for automatically supplying said material segments with values of features, thereby resulting in a feature value and corresponding material class.

9. A system according to claim 8 and further comprising:
means for automatically selecting sample reference image segments on a reference image sample not coinciding with said manually selected sample reference image segments;
means for automatically supplying said automatically selected sample reference image segments with values of features; and
means for automatically characterizing said automatically selected sample reference image segments as material segments in accordance with said values of features, thereby updating said feature value and corresponding material class.

10. A system according to claim 7 wherein said means for identifying further comprises:
means for automatically supplying said viewed image segments with values of features; and
means for automatically classifying said viewed image segments as material segments in accordance with said values of features.

11. A system according to claim 7 and wherein any of said features comprises any of the following: color intensity, hue intensity, form, elongation, area, texture, and density.

12. A system according to claim 7 and wherein said means for identifying comprises utilizing a nearest neighbor principle for comparison of said values of features with said learning set.
